(19) United States
(12) Patent Application Publication
(10) Pub. No.: US 2017/0293294 A1
(43) Pub. Date: Oct. 12, 2017

(54) SYSTEMS AND METHODS FOR DELIVERING CONTAINERS USING AN AUTONOMOUS DOLLY

(71) Applicant: Wal-Mart Stores, Inc., Bentonville, AR (US)

(72) Inventors: Michael D. Atchley, Springdale, AR (US); Donald R. High, Noel, MO (US); John P. Thompson, Bentonville, AR (US); Nathan G. Jones, Bentonville, AR (US)

(21) Appl. No.: 15/479,353

(22) Filed: Apr. 5, 2017

Related U.S. Application Data
(60) Provisional application No. 62/320,836, filed on Apr. 11, 2016.

(51) Int. Cl. G05D 1/00

(52) U.S. Cl. CPC G05D 1/0022; G05D 2201/0216

(57) ABSTRACT

In some embodiments, apparatuses and methods are provided herein useful to transporting containers using an autonomous dolly. Some of these embodiments include systems for transporting containers along delivery paths comprising: an autonomous dolly having a microcontroller and a support portion configured to carry a plurality of containers; a mobile device with a microcontroller in communication with the microcontroller of the dolly; and one or more sensors in communication with the mobile device, the one or more sensors and mobile device configured to triangulate the location of the mobile device; wherein the dolly's microcontroller is configured to receive tracking information from the mobile device's microcontroller and to cause the dolly to follow the mobile device along a delivery path defined by movement of the mobile device from a starting point to an ending point.

### CROSS-REFERENCE TO RELATED INVENTION

This invention claims the benefit of U.S. Provisional Application No. 62/320,836, filed Apr. 11, 2016, which is incorporated herein by reference in its entirety.

### TECHNICAL FIELD

This invention relates generally to transporting delivery containers along a delivery path, and more particularly, to using an autonomous dolly to transport delivery containers along a delivery path.

### BACKGROUND

One important aspect in the retail setting is the delivery of merchandise to customers. A streamlined and efficient delivery system is needed in order to satisfy customer expectations. Further, the delivery of totes, packages, or other containers imposes burdens on employees, such as delivery vehicle drivers. Drivers are often called on to unload totes from the delivery vehicle at a delivery location, transport the totes to the desired customer pick-up location, and then possibly return and load the empty totes back on the delivery vehicle. This delivery and transport imposes physical demands on drivers, who are also subject to time constraints in completing the delivery. In other words, there is a significant amount of lifting and moving work that must be accomplished in a short time.

Frequently, when totes, packages, or other containers are delivered to customers, the delivery person will use a dolly to move them to the customer pick-up location. This delivery process requires significant time to unload the dolly and totes, stack the totes on the dolly, move the merchandise, and then transfer the merchandise to the customer. Further, making numerous deliveries during the course of a day may be physically tiring to the driver. Accordingly, there is a need for a relatively low cost approach to reduce the time and effort required in making deliveries by reducing the physical effort of the driver, allowing the driver to make the delivery more efficiently, and allowing the driver to do other things while the merchandise is being moved.

### BRIEF DESCRIPTION OF THE DRAWINGS

Disclosed herein are embodiments of systems, apparatuses and methods pertaining to delivering containers using an autonomous dolly. This description includes drawings, wherein:

FIG. 1 is an illustration of a dolly in accordance with several embodiments;

FIG. 2 is a flow diagram in accordance with some embodiments;

FIG. 3 is a block diagram in accordance with several embodiments; and

FIG. 4 is an illustration in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to transporting containers using an autonomous dolly. In one form, a system disclosed herein for transporting containers along delivery paths comprising: an autonomous dolly having a first microcontroller and having a support portion configured to carry a plurality of containers; a mobile device with a second microcontroller in communication with the first microcontroller of the dolly; and one or more sensors in communication with the mobile device, the one or more sensors and mobile device configured to triangulate the location of the mobile device; wherein the first microcontroller is configured to receive tracking information from the second microcontroller and to cause the dolly to follow the mobile device along a delivery path defined by movement of the mobile device from a starting point to an ending point.

In some forms, in the system, the one or more sensors are configured to triangulate the location of the mobile device by each transmitting a signal to the mobile device and wherein the second microcontroller uses the signals to calculate a real-time location of the mobile device. Further, in the system, the second microcontroller may be configured to transmit a signal to the first microcontroller to grasp the plurality of containers and to transmit a signal to drop the plurality of containers at the ending point. In addition, the first microcontroller may be operatively coupled to a memory that is configured to retrace the delivery path from the ending point to the starting point. Also, the one or more sensors may be disposed on a delivery vehicle. Moreover, in some forms, the first microcontroller may be operatively coupled to a speaker for emitting a predetermined sound when the dolly is moving from the starting point to the ending point. In addition, the dolly may further comprise a proximity sensor to cause the dolly to stop when an obstacle is in the delivery path.

In another form, disclosed herein is a method for transporting containers along delivery paths using autonomous dollies and mobile devices, the method comprising: providing an autonomous dolly having a support portion configured to carry a plurality of containers and having a first microcontroller; providing one or more sensors and providing a mobile device having a second microcontroller; loading the plurality of containers onto the dolly; triangulating, by the one or more sensors and the mobile device, the location of the mobile device; moving the mobile device along a delivery path having a starting point and an ending point; transmitting, by the second microcontroller, tracking information indicating the location of the mobile device; and receiving, by the first microcontroller, the tracking information and causing the dolly to follow the mobile device along the delivery path from the starting point to the ending point.

In some forms, the method may include using a delivery vehicle to transport the dolly, the mobile device, the one or more sensors, and the plurality of containers to a customer location. The method may also include unloading the dolly from the delivery vehicle; and unloading the plurality of containers from the delivery vehicle. Further, the method may include transmitting a signal to the dolly to grasp one of the plurality of containers; and causing movement of the dolly from the starting point along the delivery path. In addition, the method may include manually assisting the dolly to maneuver around obstacles in the delivery path. Also, the method may include stopping movement of the dolly at the ending point along the delivery path; and transmitting a signal to the dolly to release the plurality of containers at the ending point of the delivery path. Moreover, the method may include storing the delivery path in a memory; and returning the plurality of containers from the ending point to the starting point. Further, in the method, the step of triangulation comprises transmitting one or more signals to the mobile device and using the one or more signals to calculate a real-time location of the mobile device.

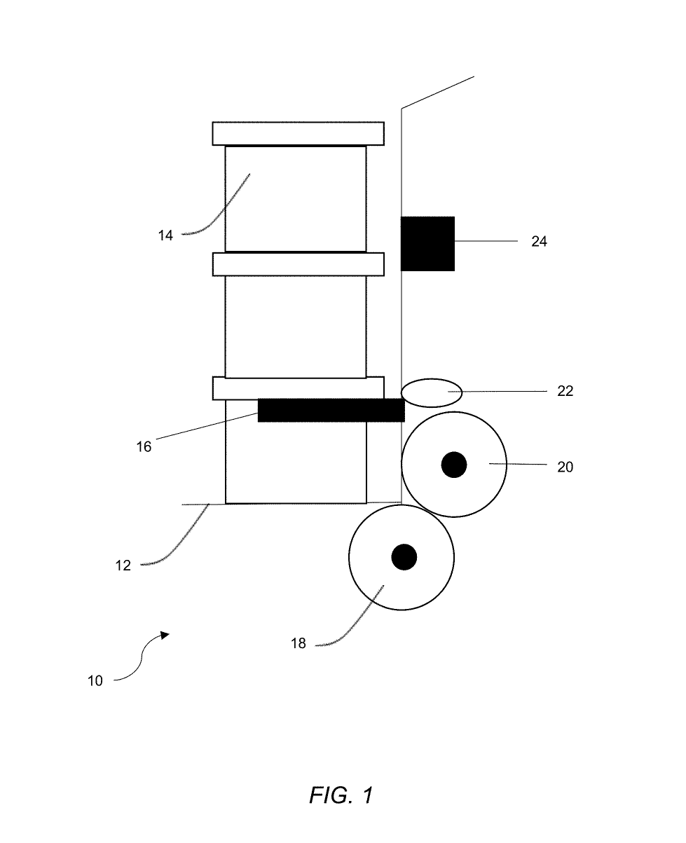

FIG. 1 is an illustration of an example of a dolly 10 that may be used with the systems and processes described herein. As can be seen in this example, the dolly 10 may include a support portion in the form of a platform 12 that carries and supports a container or tote 14. In this example, the dolly 10 is supporting three totes 14 in a stacked arrangement. The support portion also may include arms (two arms in this example) 16 that securely grasp, at least, one of the totes 14. The dolly 10 also preferably includes two self-balancing wheels 18 on which the dolly 10 moves and may also optionally include a set of stair climbing wheels 20 to assist the dolly in navigating stairs. In addition, the dolly 10 preferably includes at least one motor 22 and a lift mechanism (such as a hydraulic lift) that lowers and raises the platform 12 and/or tilts the dolly 10. Further, the dolly preferably includes a self-balancing mechanism that allows the dolly to move autonomously and maintains the dolly 10 in an upright position during the transport of the totes 14 from a delivery drop-off location to a desired customer pick-up location.

In another form, the dolly may not have a platform at all but may instead have two arms that slide under a tote. The arms may be used to grab the bottom tote just below the rim, and a flange on the end of the arms could catch and hold the first tote. A lift mechanism could raise and lower the arms to lift the stack of totes. Alternatively, the dolly could tilt backwards without having to lift the stack of totes. In other forms, the dolly or totes may include hooks or other fasteners to secure the totes to the dolly or to lock the totes together. Further, the wheels may be disposed in other positions, such as near the middle of the dolly, which may improve the dolly's balancing and stair climbing ability.

The dolly 10 also includes a microcontroller 24 that communicates with a mobile device to follow the driver (or other individual), as explained further below. The microcontroller 24 is also preferably configured to communicate and operate some or all of the platform 12, arms 16, wheels 18 and 20, motor(s) 22, lift mechanism, and self-balancing mechanism. In one form, the lift mechanism and self-balancing mechanism (which may include gyroscopes and other sensors) may be structurally integrated with the microcontroller 24 in one unitary body. Alternatively, they may be physically separate structures. The microcontroller 24 may communicate with other components and devices via wired or wireless communication. Optionally, the dolly 10 could include one or more cameras, headlights, signature capture devices for signing by customers, etc. This dolly 10 is just one example of a transport device suitable for use with the processes and systems described herein, and it should be understood that many other types of dollies with many other types of components (such as various types of support portions, arms, wheels, motors, lift mechanisms, and/or self-balancing mechanisms, in a variety of combinations) may be used as well.

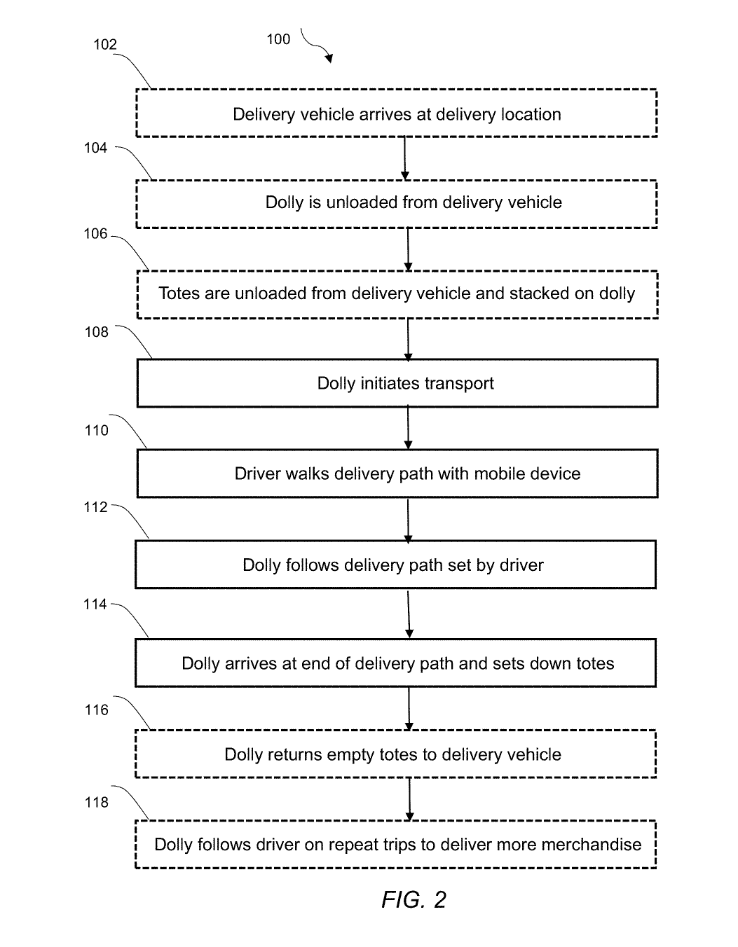

Referring to FIG. 2, there is shown a flow diagram for a process 100 of transporting containers along a delivery path using an autonomous dolly. As can be seen in the diagram, the process 100 preferably involves the use of an autonomous dolly by the driver of a delivery vehicle (or other individual involved in transporting merchandise from the delivery vehicle). The process uses a low-cost approach for guiding the autonomous dolly from a delivery drop-off location to a customer pick-up location, thereby reducing the burden on the driver.

At block 102, FIG. 2 illustrates the delivery vehicle arriving at a delivery location (or delivery drop-off location) for delivering merchandise to a customer. It is generally contemplated that the delivery vehicle will transport the driver (and possibly other individuals) with mobile device(s), the dolly, containers/totes holding the merchandise, and sensor(s). Although, in one form, it is contemplated that the process will involve a delivery vehicle, this component is not a necessary component. In some forms, it is contemplated that the process may simply involve an individual with mobile device transporting containers (such as totes) along a delivery path using an autonomous dolly without necessarily having arrived via delivery vehicle. In addition, for example, the dolly could receive directions for navigation from a remote base station via wireless communication.

At block 104, assuming the use of a delivery vehicle, the dolly is unloaded from the delivery vehicle. This unloading may be accomplished in various ways. In one form, it is contemplated that the driver (or other individual) may manually remove the dolly from the delivery vehicle, possibly by undocking the dolly from a docking station on the delivery vehicle. In other forms, the delivery vehicle or dolly may be equipped with a microcontroller that is configured to sense that the dolly has reached its destination and to automatically cause the dolly to be unloaded from the delivery vehicle, such as by unlocking the dolly from a docking station and lowering the dolly to the ground. Alternatively, the microcontroller may be instructed remotely that the destination has been reached and that the above dolly unloading operation should be undertaken.

At block 106, again assuming the use of a delivery vehicle, the delivery containers (such as totes) are unloaded from the delivery vehicle and stacked on the dolly. This unloading of delivery containers may also be accomplished in several different ways. In one form, the delivery containers may simply be unloaded manually from the delivery vehicle by the driver (or other individual). In other forms, the delivery vehicle may be equipped with a robotic arm (or other unloading mechanism) to assist in the removal the totes and in depositing them on the dolly. A robotic arm (or other unloading mechanism) may be especially desirable when the totes are intended to hold heavy loads.

At block 108, the autonomous dolly initiates transport, preferably by securely grasping and lifting the totes. The driver (or other individual) may transmit a remote command to the dolly's microcontroller to grasp and/or lift the totes. Alternatively, the driver (or other individuals) may trigger an actuator on the dolly to cause the dolly to grasp and/or lift the totes, or there may be some combination of remote instruction or actuator. It is contemplated that the dolly will balance itself on two wheels (although other dolly structures are possible) and will be ready to begin transporting the totes along the delivery path. Additional detail regarding various options for dolly structure is provided below.

At block 110, the driver (or another individual) walks the delivery path with a mobile device. In some forms, the driver (or other individual) may physically carry some other delivery containers or may maneuver a second, non-autonomous dolly that supports delivery containers (such as totes). As explained below, the autonomous dolly then follows the driver (or other individual) with additional delivery containers. In this form, the process 100 may allow the transport of more delivery containers during each trip. In some forms, the driver may pre-program a specific delivery path for the autonomous dolly to follow. Accordingly, the process 100 makes transport of the delivery containers from the delivery drop-off location to the customer pick-up location more efficient and saves delivery time.

At block 112, the autonomous dolly follows the delivery path set by the driver (or other individual) with the mobile device. As explained further below, the mobile device includes a microcontroller that is in communication with a microcontroller on the dolly. Further, in some forms, sensor(s) are mounted nearby and may be mounted on the delivery vehicle. The mobile device's microcontroller and sensor(s) are configured to triangulate the position of the mobile device along the delivery path, and this position is communicated to the following autonomous dolly. In other words, the mobile device's microcontroller and sensor(s) establish a collection of real-time position estimates (or a “bread crumb trail” or digital trail) that approximate the actual delivery route established by the driver (or other individual). The autonomous dolly follows the mobile device along the delivery path defined by the movement of the mobile device from a starting point to an ending point

There are various known triangulation approaches that may be used to establish the real-time position of the mobile device. The sensor(s) may include a certain, desired number of sensor(s) arranged according to a desired location or pattern in a certain area. For example, in one form, the process may use two sensors that are mounted on opposite ends of the delivery vehicle. With this arrangement, it is possible to triangulate the location of the mobile device by the signals and interaction of the mobile device and sensor(s) based on the different distances and angles from the sensor(s) to the mobile device. The accuracy of triangulation may depend on the number and arrangement of the sensor(s), and any of various types of sensor(s) may be used. For example, the sensor(s) may be navigational beacons using ultrasonic, radio, laser, optical, or other types of signals to determine the location of the mobile device. The sensor(s) can transmit signals and distance can be determined by the measured reflection of the signals. Also, the sensor(s) can use Bluetooth or other wireless technologies for communicating data over relatively short distances. Further, although one general triangulation approach has been described, any of various existing localization techniques and algorithms may be used and appropriate in certain circumstances. These triangulation approaches represent a low cost approach for providing navigation and guidance to the autonomous dolly.

At block 114, the autonomous dolly has followed the driver along the delivery path from starting point to arrive at the ending point. When the dolly arrives at the end of the delivery path, it sets down the delivery containers, or totes. In one form, the dolly microcontroller may receive a command from the mobile device microcontroller instructing the dolly to set down the totes. The dolly has completed transport of the totes to the customer pick-up location, and the driver removes the merchandise from the totes.

At block 116, the autonomous dolly may then return the empty totes to the delivery vehicle. In one form, the dolly microcontroller may include a memory portion that stores the delivery path, and the dolly may be commanded to automatically retrace the delivery path from the ending point to the starting point. Alternatively, in other forms, the driver himself may physically maneuver the dolly back to the starting point. As shown in block 118, this process of transporting merchandise may be repeated if there are more totes to be delivered. For example, in one form, blocks 106 to 114 may be repeated to deliver more merchandise to the customer pick-up location.

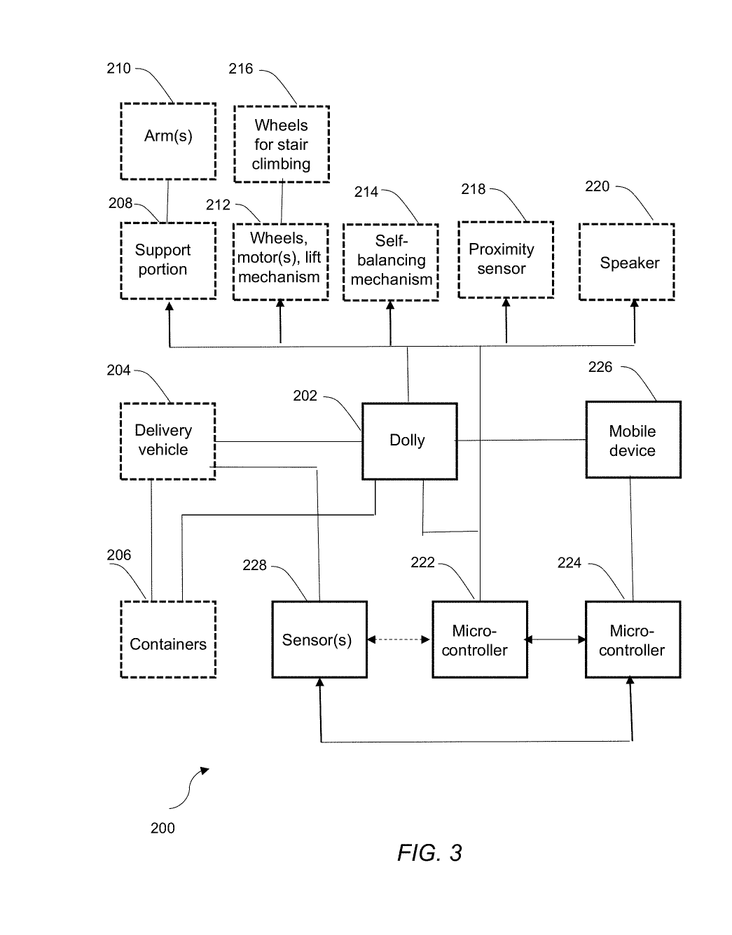

Referring to FIG. 3, there is shown a block diagram illustrating various components of the system 200. As described above, the system 200 includes an autonomous dolly used to transport containers to a customer pick-up location. The dolly has a microcontroller in communication with the microcontroller of a mobile device to receive guidance information and follow a delivery path.

As described above, in one form, it is generally contemplated that the dolly 202 may be carried by a delivery vehicle 204 and unloaded from the delivery vehicle 204 upon arrival at a delivery location. After the dolly 202 is unloaded, containers (or totes) 206 may be deposited on the dolly 202. It is contemplated that the containers 206 may be deposited on the dolly in a stacked arrangement, one container atop another container. Further, the containers 206 preferably include features that assist in this stacking arrangement, such as a raised flange around the lid perimeter of each container to maintain a container atop another container.

Generally, the dolly 202 may include any device or assembly capable of transporting merchandise. However, as can be seen in the diagram, the dolly 202 may have various structural features that assist in the transport of the containers 204. The dolly 202 preferably has a support portion 208 for holding and securing the containers 204. In one form, this support portion 208 may include a flat platform on which the containers are stacked. Further, this support portion 208 may include one or more arms 210 (preferably two arms to initially grasp and then hold the containers 204 securely to the dolly 202 during transport). The support portion 208 may be operated manually (such as by the driver) or by remote command or instruction.

The dolly 202 preferably includes additional features that help make it an autonomous dolly. The term “autonomous” generally refers to the ability of the dolly 202 to operate generally without assistance by individuals during transport of containers 204, i.e., an individual need not physically push, pull, or exert a force against the dolly 202. Instead, the dolly 202 is able to respond to remote commands/instruction/guidance to navigate the delivery path on its own from a starting point to an ending point.

As shown in block 212, the dolly 202 preferably includes wheels (preferably two wheels), one or more motors to power the dolly 202 (preferably a motor at each wheel), and a lift mechanism (to raise and lower the containers 204 such as via the support platform 208. The dolly 200 preferably includes the lifting mechanism to initially lift the containers 204 and balances on two wheels during transport of the containers 204 to the customer pick-up location. The dolly 202 also preferably includes a self-balancing mechanism 214, such as in the form of one or more gyroscopes, to assist in maintaining the balance and upright orientation of the dolly 202. As explained further below, these structural features are preferably coupled to and respond to instructions from the dolly's microcontroller.

The dolly 202 may include additional optional structural features. For example, the dolly 202 may include one or more additional wheels 216 for climbing stairs. Additionally, the dolly 202 may include a proximity sensor 218 that detects obstacles in the delivery path. As the dolly 202 follows the driver (or other individual), the driver will generally avoid obstacles, but it is contemplated that an obstacle may appear in the delivery path after the driver has walked past, the dolly 202 may deviate slightly from the delivery path so as to encounter an obstacle, or the dolly may be commanded to retrace the delivery path back to the starting point and may encounter an obstacle. To address this possibility, the dolly 202 may be equipped with a proximity sensor 218 to detect such obstacles and to stop the dolly 202 until the proximity sensor 218 no longer detects the obstacle. Alternatively, the dolly 202 need not have a proximity sensor 218, and instead, the driver may manually assist the dolly 202 to maneuver around obstacles. The dolly 202 may also be equipped with a speaker 220 that emits a certain desired sound to provide an alert during transport to individuals in the area of the motion of the dolly 202. Again, these additional structural features are preferably operatively coupled to the microcontroller.

The dolly 202 navigates itself along the delivery path from a starting point to an ending point via microcontroller 222. As described herein, the microcontroller 222 may be integrated with the dolly 202, mounted or fastened to the dolly 202 in any manner, or may be part of a discrete, separate structure. The term microcontroller refers broadly to any control circuit, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The microcontroller 222 may be configured (for example, by using corresponding programming stored in a memory as will be well understood by those skilled in the art) to carry out one or more of the steps, actions, and/or functions described herein.

The dolly's microcontroller 222 is preferably in wireless communication with a microcontroller 224 of a mobile device 226 of a driver (or other individual). The mobile device 226 may be any of various types of portable computing devices, including, for example, smartphones, tablet computers, or fobs. The mobile device 226 is preferably a handheld device in the possession of the driver (or other individual) as he moves along the delivery path.

The mobile device microcontroller 224 is preferably also in wireless communication with one or more sensors 228. In one form, two sensors may be mounted on the delivery vehicle 204, and they may be mounted near opposite ends of the delivery vehicle 204. The sensor(s) 228 communicate and cooperate with the mobile device microcontroller 224 to triangulate the position of microcontroller 224 and to provide an accurate real-time location of the microcontroller 224. It has been found that the use of nearby sensor(s) provides a more accurate determination of location than other localization approaches that do not use nearby sensors, such as GPS. It has been found that GPS provides a rough estimate of location that does not necessarily result in a well-defined delivery path that can be followed by the dolly 202 in many circumstances. As explained above, any of various triangulation and localization approaches using such nearby sensor(s) may be used.

After a position is triangulated, the mobile device microcontroller 224 transmits the real-time tracking information to the dolly microcontroller 222. The mobile device microcontroller 224 and sensor(s) 228 are preferably configured to perform triangulation/localization and to generate tracking information according to desired time intervals. The time intervals are preferably of sufficient length so that the “bread crumb trail” closely approximates the delivery path established by the driver (or other individual) and so that the tracking information provided to the dolly microcontroller 222 allows smooth movement by the dolly 202. It is understood generally that statements referring to the dolly following the delivery path herein indicate that the dolly is approximating the delivery path defined by the driver. In turn, the dolly microcontroller 222 preferably communicates with and controls operation of the dolly features (i.e., wheels, motors, self-balancing mechanism, etc.) to cause the dolly 202 to follow the mobile device 226.

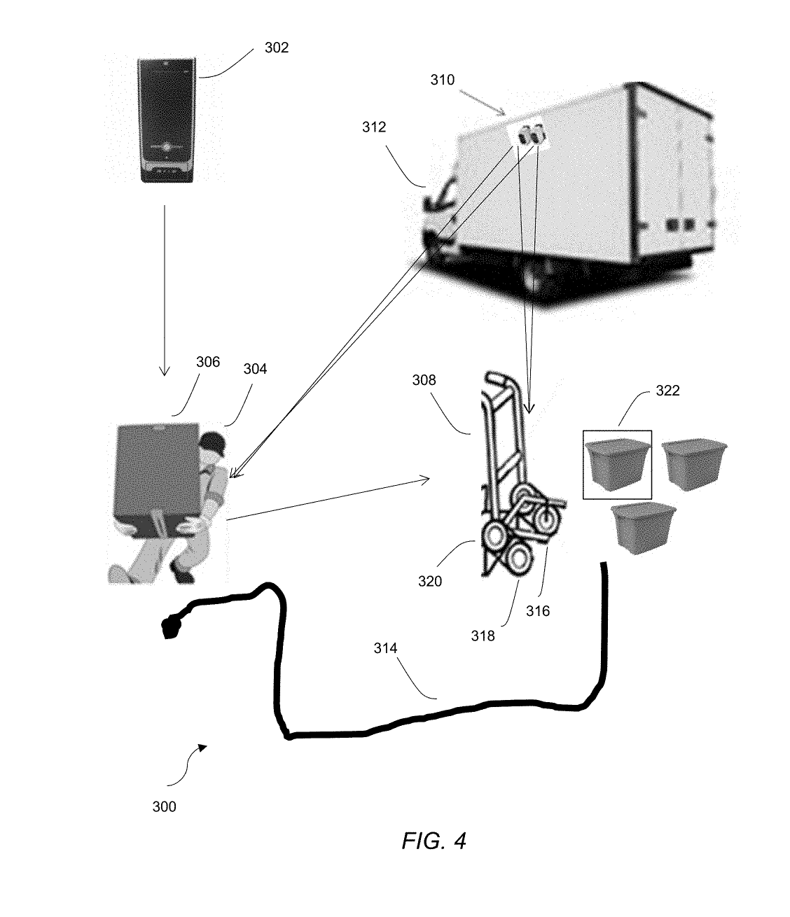

FIG. 4 shows a diagram illustrating various components of a similar system 300. In this form, there is shown a remote server or central processor 302 that is in communication with a mobile device of the driver 304, such as, for example, a smartphone. The central processor 302 preferably communicates the order information to the driver's smartphone, such as, for example, customer identification information, delivery location, and/or type and amount of merchandise ordered. This order information may be communicated to the driver 304 at any of various times during the entire delivery process.

In this form, the driver 304 is shown carrying a delivery container or package 306. The driver 304 may decide to carry some of the delivery containers 306 in order to expedite and reduce the length of time of the delivery. The driver 304 and the autonomous dolly 308 may reduce the number of total trips from the delivery drop-off location to the customer pick-up location. Further, the driver 304 may be able to limit physical exertion by using a second, non-autonomous dolly or by carrying lighter loads.

Further, as can be seen in the diagram, two sensors 310 are mounted on the delivery vehicle 312. In this particular form, they are preferably mounted side-by-side intermediate the vehicle length and near the top of the delivery vehicle 312. As should be evident, a different number of sensors may be used, and they may be positioned at other locations on the delivery vehicle 312.

In this form, the sensors 310 cooperate in triangulating the real-time position of the driver's smartphone. As shown in FIG. 3, the sensors 310 may be in communication with both the smartphone and with the microcontroller on the autonomous dolly 308. As should be evident, the sensors 310 may cooperate with the driver's smartphone and/or the dolly's microcontroller to generate tracking information under any of various triangulation/localization approaches and algorithms. As shown in this example, the sensors 310 track the smartphone and then communicate this tracking information to the dolly's microcontroller. The smartphone may also communicate information regarding its position to the dolly's microcontroller. The dolly's microcontroller may then use these various inputs to calculate a best estimate of the real-time position of the smartphone at desired time intervals. The sequential collection of best estimates over time defines the “bread crumb trail” and approximates the delivery path 314 followed by the driver 304. The dolly's microcontroller converts this tracking information into commands/instructions to the wheels, motor(s), lifting mechanism, and/or self-balancing mechanism to cause the dolly 308 to follow the delivery path 314. The time intervals are also preferably selected so as to approximate the driver's route and to generate relatively smooth movement by the dolly. In another form, as described above, the calculations may be made by the driver's smartphone and communicated to the dolly 308, or they may be performed by a separate computing device coupled to the sensors 310.

In another form, the sensors 310 on the delivery vehicle 312 may communicate and cooperate with the dolly microcontroller to confirm that the dolly is on or close to the delivery path defined by the driver 304. The sensors 310 and dolly microcontroller may use triangulation to determine real-time estimates of the dolly's position and compare that position to the delivery path. Further, they may be configured to provide correction if there is a significant discrepancy, i.e., the dolly's position deviates from the delivery path by some determined amount.

In this diagram, the dolly 308 is shown in an unloaded condition to better show various features, such as the arms 316, standard wheels 318, and stair climbing wheels 320. Three delivery containers or totes 322 are shown next to the dolly 308 and are preferably loaded in a stacked arrangement on the dolly 308. Of course, it is understood that the dolly 308 would likely be loaded (possibly by the driver or an unloading mechanism on the delivery vehicle 312) before the driver begins walking toward the customer pick-up location. Further, the sensors 310 and microcontrollers may be arranged to try to maintain any of various desired distances between the driver 304 and the dolly 308.

It is also contemplated that the systems methods described herein could be used with teams of autonomous dollies. In other words, several autonomous dollies could be used for large deliveries or deliveries involving especially heavy merchandise. It is contemplated generally that the autonomous dollies would use the systems and methods described herein to follow a delivery path defined by a driver (or other individual). In this circumstance, they would preferably also communicate with one another and be able to determine the relative positions of the other autonomous dollies in the team.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for transporting containers along delivery paths comprising:
an autonomous dolly having a first microcontroller and having a support portion configured to carry a plurality of containers;
a mobile device with a second microcontroller in communication with the first microcontroller of the dolly; and
one or more sensors in communication with the mobile device, the one or more sensors and mobile device configured to triangulate the location of the mobile device;
wherein the first microcontroller is configured to receive tracking information and to cause the dolly to follow the mobile device along a delivery path defined by movement of the mobile device from a starting point to an ending point.

2. The system of claim 1, wherein the support portion of the dolly comprises two arms that engage and support one of the plurality of containers.

3. The system of claim 1, wherein the support portion of the dolly is configured to support the plurality of containers in a stacked arrangement.

4. The system of claim 1, wherein the dolly further comprises a plurality of wheels, at least one motor, and a lift mechanism configured to tilt the dolly.

5. The system of claim 1, wherein the dolly further comprises a self-balancing mechanism configured to maintain the dolly in an upright position during movement along the delivery path.

6. The system of claim 1, wherein the one or more sensors are configured to triangulate the location of the mobile device by each transmitting a signal to the mobile device and wherein the second microcontroller uses the signals to calculate a real-time location of the mobile device.

7. The system of claim 1, wherein the second microcontroller is configured to transmit a signal to the first microcontroller to grasp the plurality of containers and to transmit a signal to drop the plurality of containers at the ending point.

8. The system of claim 1 wherein the first microcontroller is operatively coupled to a memory that is configured to retrace the delivery path from the ending point to the starting point.

9. The system of claim 1, wherein the one or more sensors are disposed on a delivery vehicle.

10. The system of claim 1, wherein the first microcontroller is operatively coupled to a speaker for emitting a predetermined sound when the dolly is moving from the starting point to the ending point.

11. The system of claim 1, wherein the dolly further comprises a proximity sensor to cause the dolly to stop when an obstacle is in the delivery path.

12. A method for transporting containers along delivery paths using autonomous dollies and mobile devices, the method comprising:
providing an autonomous dolly having a support portion configured to carry a plurality of containers and having a first microcontroller;
providing one or more sensors and providing a mobile device having a second microcontroller;
loading the plurality of containers onto the dolly;
triangulating, by the one or more sensors and the mobile device, the location of the mobile device;
moving the mobile device along a delivery path having a starting point and an ending point;
transmitting tracking information indicating the location of the mobile device; and
receiving, by the first microcontroller, the tracking information and causing the dolly to follow the mobile device along the delivery path from the starting point to the ending point.

13. The method of claim 12, further comprising:
using a delivery vehicle to transport the dolly, the mobile device, the one or more sensors, and the plurality of containers to a customer location.

14. The method of claim 13, further comprising:
unloading the dolly from the delivery vehicle; and
unloading the plurality of containers from the delivery vehicle.

15. The method of claim 12, further comprising:
transmitting a signal to the dolly to grasp one of the plurality of containers; and
causing movement of the dolly from the starting point along the delivery path.

16. The method of claim 12, further comprising:
manually assisting the dolly to maneuver around obstacles in the delivery path.

17. The method of claim 12, further comprising:
stopping movement of the dolly at the ending point along the delivery path; and
transmitting a signal to the dolly to release the plurality of containers at the ending point of the delivery path.

18. The method of claim 12, further comprising:
storing the delivery path in a memory; and
returning the plurality of containers from the ending point to the starting point.

19. The method of claim 12, wherein the step of triangulation comprises transmitting one or more signals to the mobile device and using the one or more signals to calculate a real-time location of the mobile device.

20. The method of claim 12, further comprising:
determining the real-time position of the dolly;
comparing the real-time position to the delivery path; and
providing correction if the real-time position deviates from the delivery path a predetermined amount.
